(19) United States
(12) Patent Application Publication
(10) Pub. No.: US 2026/0334458 A1
(43) Pub. Date: Oct. 29, 2026

(54) NUISANCE ANIMAL RESTRAINING AND DISPATCH DEVICE

(71) Applicant: Daniel Pierro, JR., Austin, TX (US)

(72) Inventor: Daniel Pierro, JR., Austin, TX (US)

(21) Appl. No.: 19/188,857

(22) Filed: Apr. 24, 2025

(51) Int. Cl. A01M 99/00; A01K 15/04

(52) U.S. Cl. CPC A01M 99/00; A01K 15/04

(57) ABSTRACT

A nuisance animal restraining and dispatch device includes an elongated body having a first end and a second end. A restraining mechanism and a dispatch mechanism are located at the first end. A dispatch mechanism control is positioned at the second end for activating the dispatch mechanism. The restraining mechanism may comprise an elastic member spanning a gap between opposing members. The dispatch mechanism may include one or more blades configured to cut an animal. The dispatch mechanism control can include a spring-loaded rod, a lever, or a cable operably connected to the dispatch mechanism. The device enables safe restraint and dispatch of nuisance animals.

### FIELD OF INVENTION

The present disclosure relates to animal restraining and dispatch devices, and more particularly to an elongated device for safely restraining and dispatching nuisance animals such as snakes using a combination of mechanical restraints and cutting mechanisms.

### BACKGROUND

The presence of nuisance animals such as snakes pose a potential danger to people and pets, particularly around residential areas. Dealing with snakes often presents challenges due to their ability to strike from a distance and their quick movements. Many individuals lack specialized tools or knowledge for safely handling and relocating unwanted snakes.

Common approaches to snake encounters may include calling animal control services or improvising with household items like garden tools. However, these methods can have drawbacks. Animal control services may not always be readily available or convenient, especially in rural areas. Improvised tools can be cumbersome to use and may put the user at risk of snake bites if not handled properly.

As encounters with snakes continue to occur in both urban and rural environments, there remains an ongoing interest in developing practical solutions that address the challenges associated with snake management. It would therefore be beneficial to have a device which can be used with little training or experience to restrain, move, or dispatch a nuisance animal when the need arises.

### SUMMARY

An animal restraining and dispatch device is provided. The device includes an elongated body having a first end and a second end. The device further includes a restraining mechanism at the first end, a dispatch mechanism at the first end, and a dispatch mechanism control at the second end for activating the dispatch mechanism.

According to other aspects of the present disclosure, the device may include one or more of the following features. The dispatch mechanism may comprise one or more blades configured to cut an animal. The restraining mechanism may comprise an elastic member spanning a gap between opposing members. The dispatch mechanism control may comprise a spring-loaded rod attached to the dispatch mechanism or a lever for activating the dispatch mechanism. The lever may be operably connected to the dispatch mechanism by a cable.

According to another aspect of the present disclosure, an animal restraining and dispatch device is provided. The device includes an elongated body, a pair of opposing blades pivotally connected to the elongated body at a first end, a restraining mechanism comprising an elastic member spanning a gap between the opposing blades, and a control mechanism at a second end of the elongated body operably connected to the opposing blades.

According to other aspects of the present disclosure, the device may include one or more of the following features. The control mechanism may comprise a cable operably connected to the opposing blades. The control mechanism may further comprise a spool around which the cable is wound, wherein rotation of the spool causes tension in the cable which activates the opposing blades. The control mechanism may further comprise a lever for rotating the spool. The lever may drive a pawl that engages with a gear attached to the spool to rotate the spool. The device may further comprise a lock member configured to engage with the gear to prevent unintended rotation of the spool. The lock member may be biased towards engagement with the gear by a lock spring.

According to another aspect of the present disclosure, a method of restraining and dispatching an animal is provided. The method includes positioning an animal within a gap between opposing blades at a first end of an elongated device, restraining the animal using an elastic member spanning the gap, and activating a dispatch mechanism at the first end using a control mechanism at a second end of the elongated device to hold or dispatch the animal.

According to other aspects of the present disclosure, the method may include one or more of the following features. Activating the dispatch mechanism may comprise pulling a cable connected to the opposing blades to close the blades. Pulling the cable may comprise rotating a spool around which the cable is wound. Rotating the spool may comprise actuating a lever operably connected to the spool. The method may further comprise engaging a lock member with the spool to prevent unintended rotation of the spool. The method may further comprise disengaging the lock member to release the opposing blades and release the animal.

The foregoing summary has outlined some features of the apparatus, system, and method of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other structures for carrying out the same purpose of the apparatus, system, and method disclosed herein. Those skilled in the pertinent art should also realize that such equivalent designs or modifications do not depart from the scope of the apparatus, system, and method of the present disclosure.

### BRIEF DESCRIPTION OF FIGURES

These and other features, aspects, and advantages of the present invention will become better understood with regard to the following description, appended claims, and accompanying drawings where:

FIG. 1 illustrates an oblique view of an animal restraining and dispatch device, according to a preferred embodiment.

FIG. 2 depicts a side view of the animal restraining and dispatch device, according to an embodiment.

FIG. 3 shows an oblique section view of a dispatch mechanism control portion of the animal restraining device, in accordance with example embodiments.

FIG. 4 illustrates a side view of an animal dispatch device, according to embodiments of the present disclosure.

FIG. 5 depicts a side partial section view of an animal restraining and dispatch device, according to an embodiment.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally. The term “comprises” and grammatical equivalents thereof are used herein to mean that other components, ingredients, steps, etc. are optionally present. For example, an article “comprising” components A, B, and C can contain only components A, B, and C, or can contain not only components A, B, and C, but also one or more other components.

The present disclosure relates to an animal restraining and dispatch device. In some embodiments, an animal restraining and dispatch device may be used to safely capture and humanely dispatch animals, particularly snakes or other potentially dangerous creatures. The animal restraining and dispatch device may comprise an elongated body with a restraining mechanism and a dispatch mechanism at one end, and a control mechanism at the opposite end. The restraining mechanism may hold the animal while the dispatch mechanism is activated. The dispatch mechanism may be designed to securely hold the animal temporarily and then release the animal or dispatch the animal if desired.

In some embodiments, a dispatch device may be configured to restrain an animal within a gap between opposing members. By first restraining the animal, the user can quickly get the animal under control while getting close enough to identify the species, such as a venomous or non-venomous snake, and then release, move, or dispatch as desired. The dispatch device may include a cutting mechanism that can be activated to dispatch the restrained animal. The dispatch device may also be used to hold the animal for capture or moving the animal. The cutting mechanism may be controlled by a user-operated mechanism at the opposite end of the device, allowing for safe operation at a distance from the animal.

The animal restraining and dispatch device may be designed for ease of use, allowing individuals with limited experience to effectively handle potentially dangerous animals. In some embodiments, the device may incorporate safety features to prevent accidental activation of the dispatch mechanism.

Multiple embodiments of the animal restraining and dispatch device will be described in detail, illustrating various configurations and mechanisms that may be employed in the design and operation of the device.

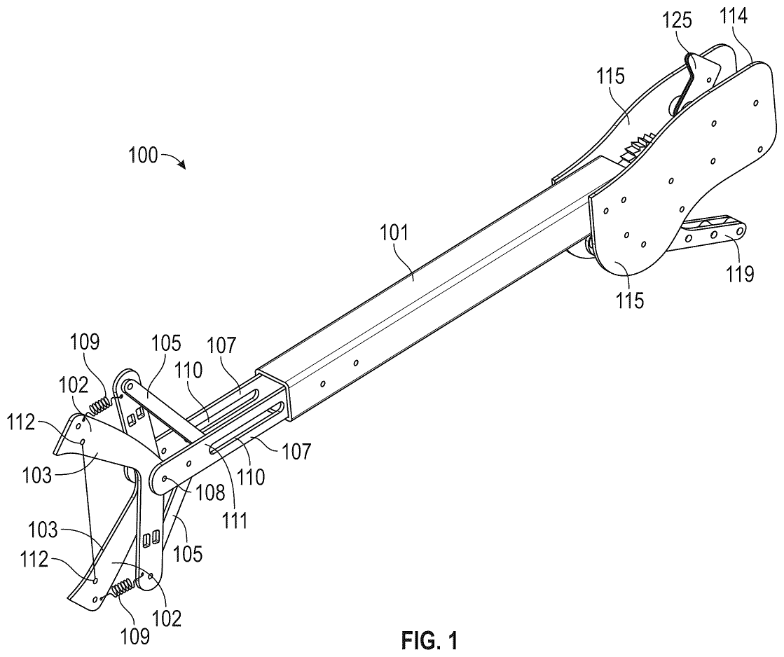

In one preferred embodiment shown in FIGS. 1-3, the animal restraining and dispatch device 100 may comprise a main body 101. The main body 101 may be made from rectangular tubing. At one end of the main body 101, the animal restraining and dispatch device 100 may include a pair of blades 102 having a boomerang-like shape. Each blade 102 may have an edge 103 which may be sharpened.

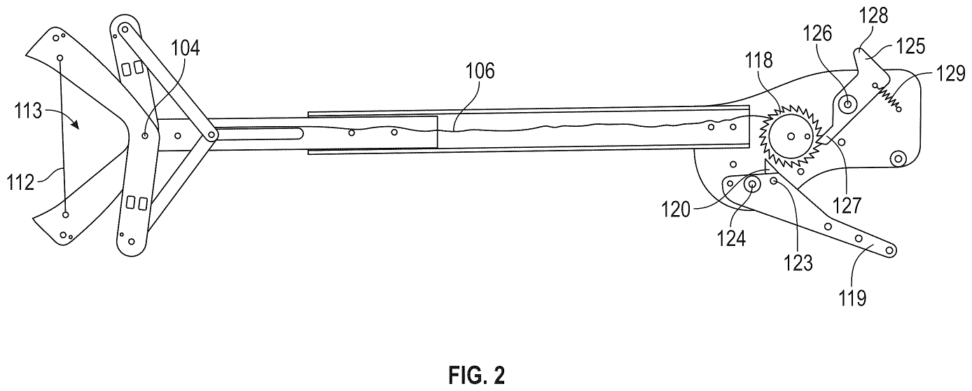

The animal restraining and dispatch device 100 may include a pivot hole 104 for each blade 102. The pivot hole 104 may allow the blades 102 to pivot relative to the main body 101. Linkage bars 105 may be connected to the blades 102 to control their movement. In the embodiment shown in FIGS. 1-2, one end of each of the linkage bars 105 is pivotally connected to the ends of the blades 102 opposite the edge 103. The other ends of the linkage bars 105 are connected together as explained below.

Support arms 107 may extend from the main body 101 to hold components of the dispatch device. The support arms 107 may be thin elongated members formed of metal or other suitable material. In some embodiments, the support arms 107 may be integrally formed with the main body 101, while in other embodiments the support arms 107 may be attached to the main body 101. The support arms 107 may include blade pivot holes 108 for mounting the blades 102. A pin may pass through blade pivot holes 108 in support arms 107 as well as through pivot holes 104 in blades 102 to pivotally connect the blades 102 to the support arms 107. Spacers or washers may be placed between the components such as the blades and support arms to reduce friction or provide clearance.

Extension springs 109 may be attached from one blade to another to provide opening force for the blades 102. Guide slots 110 may be formed in the support arms 107 to constrain the movement of linkage bars 105 in a linear fashion. Linkage pin 111 in the form of a threaded fastener or pin may pass through the guide slots 110 and holes in the ends of linkage bars 105 to guide the movement of the linkage bars 105. In operation, the linkage pin 111 riding in the guide slots 110 hold the blades at a particular orientation as the blades are pulled together or apart. Thus, upon activation of the dispatch mechanism, the blades move symmetrically towards each other in a cutting motion.

In some embodiments, the animal restraining and dispatch device 100 may include a control cable 106 that extends along the length of the main body 101. The control cable 106 may be operably connected to the dispatch control mechanism and the blades 102 to control their movement. Particularly, control cable 106 may be connected to the linkage pin 111, linkage bars 105, or otherwise located so as to cause the blades to come together when tension is applied to the control cable 106.

The restraining mechanism may be comprised of an elastic member 112 which may span across a blade gap 113 between the blades 102. The elastic member 112 may be used to restrain the animal temporarily between the blades 102. The elastic nature of these materials allows the restraining mechanism to conform to the shape of the captured animal, providing a secure hold while minimizing the risk of injury during the restraining process. The allows the user to identify the type of animal and whether it is dangerous or not. The animal may then be released by lifting the device off the animal, releasing the restraining mechanism.

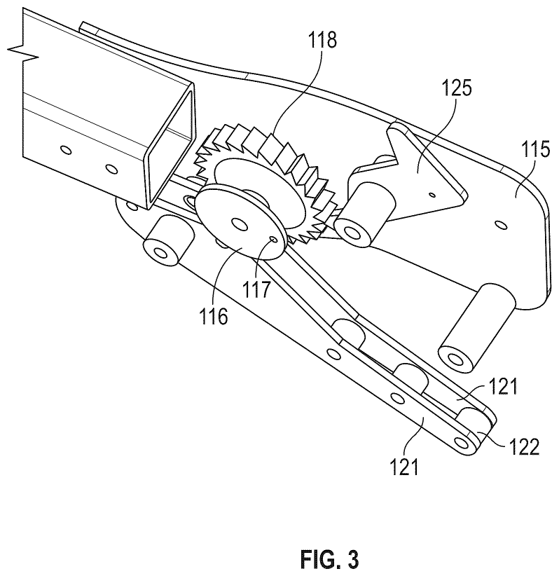

At the opposite end of the animal restraining and dispatch device 100, a control handle 114 may be provided for holding and using the device. In some embodiments, the control handle 114 of the animal restraining and dispatch device 100 may include internal components as shown in FIGS. 2 and 3. FIG. 3 oblique section view of a dispatch mechanism control portion of the animal restraining device, revealing the arrangement and interaction of various elements within the handle assembly.

The control handle 114 may include ergonomically contoured handle plates 115 mounted on either side of the main body 101 and shaped to fit comfortably in a user's hand. Between the handle plates 115, a cable spool 116 may be positioned. The cable spool 116 may be a cylindrical component around which the control cable 106 may be wound. The spool 116 may have a small central diameter flanked by larger outer diameter sections to guide the control cable 106. In some embodiments, the cable spool 116 may include a cable hole 117. The cable hole 117 may be an opening in the cable spool 116 through which the control cable 106 may be secured.

Connected to or integrated with the cable spool 116 is a spool gear 118. The spool gear 118 may feature a series of teeth around its circumference. The spool gear 118 may be configured to rotate with the cable spool 116, translating rotational motion into linear motion of the control cable 106.

A trigger mechanism 119 may be incorporated into the control handle 114 for actuating the cutting mechanism. The trigger mechanism 119 may rotate around a trigger pivot 124, which may be comprised of a pin or a threaded fastener through holes in the handle plates 115 and trigger mechanism 119.

The trigger mechanism 119 may work in conjunction with a pawl 120 which may be pivotally connected at pivot point 123 to the trigger mechanism 119. The pawl 120 may engage with teeth of the spool gear 118 to control the movement of the blades 102. In some embodiments, the pawl 120 may be spring-loaded with a torsion spring or other device to maintain engagement with the spool gear 118. As the trigger mechanism 119 is squeezed, the pawl 120 pushes the gear 118 in a circular motion. When the trigger mechanism 119 is released, a spring or other mechanism causes the trigger mechanism to reverse during which the pawl 120 skips over the teeth of spool gear 118. Thus, the trigger mechanism 119 only moves the gear in one direction.

Trigger mechanism 119 may be comprised of trigger plates 121 which may be positioned within the space created by the handle plates 115. One or more trigger spacers 122 may be included to provide rigidity and proper spacing between components of the trigger mechanism 119.

A locking system is included which holds the blades from opening against the spring force of extension springs 109. The lock system is comprised of a lock member 125 which may rotate around a lock pivot 126. A lock pawl 127 on the lock member 125 may engage with the teeth of gear 118 to maintain the position of the blades 102. A lock protrusion 128 may extend from the lock member 125 to allow for user to release the locking mechanism. A lock spring 129 may provide tension to maintain engagement of the lock pawl 127 until release is desired.

The components of the control mechanism may be arranged to work together, with the control cable 106 transferring force from the trigger mechanism 119 through the main body 101 to operate the blades 102. The trigger mechanism 119 and associated pawl 120 may convert the user's input into mechanical movement, while the locking system prevents unintended blade movement during operation.

Using the controls, the nuisance animal restraining and dispatch device 100 may be used as follows. First, an animal is spotted by the user and the device is placed over the animal such that the restraining mechanism temporarily holds the animal in place. The elastic member 112 of the restraining mechanism may conform around the animal, placing pressure on the animal to restrain it without causing harm to the animal. This may give the user more time to identify the animal and decide on a course of action. If the user decides to release the animal, the user may simply lift the device off the animal, releasing the restraining mechanism and allowing the animal to escape.

If the user desires to further restrain the animal or move the animal, the dispatch mechanism may be activated via the dispatch control mechanism (i.e. squeeze the trigger mechanism) to close the blades around the animal without cutting the animal. The animal may then be picked up and placed into a container such as a bag or bucket or simply moved with the device. The lock member 125 may then be used to release the blades which open under the spring force, releasing the animal with minimal harm. If dispatch is desired, the dispatch control mechanism may be further used to cause the dispatch mechanism to cut the animal to dispatch it.

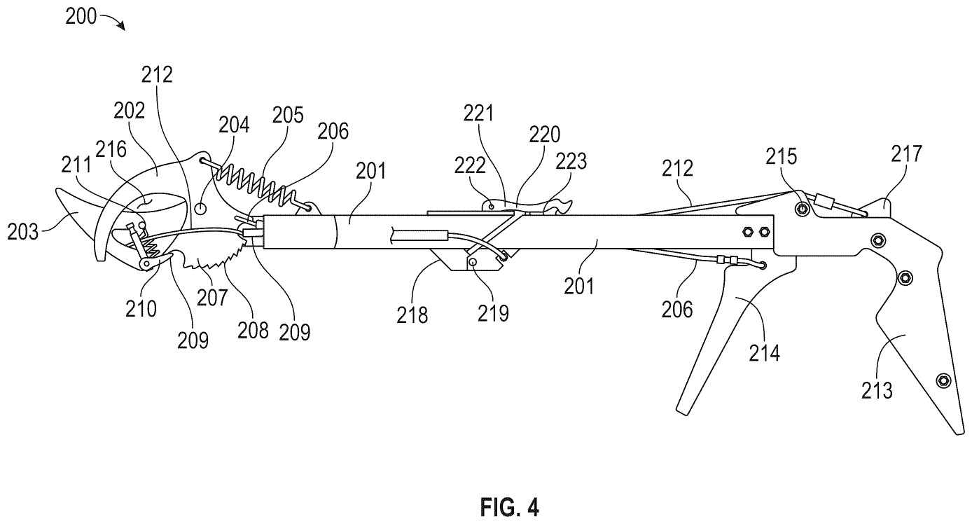

According to another preferred embodiment, the animal restraining and dispatch device may comprise a dispatch device 200 as shown in FIG. 4. The dispatch device 200 may include a cylindrical tubular body 201 that serves as the main structural component.

At one end of the tubular body 201, the dispatch device 200 may include a dispatch mechanism comprising a movable blade 202 and a stationary blade 203. The movable blade 202 and the stationary blade 203 may be pivotally connected by a pivot pin 204 which may pass through holes in the blades. In some embodiments, the movable blade 202 or the stationary blade 203 may be angled, pointed, or perpendicular to the central axis of the tubular body 201.

A blade spring 205 may be connected to the movable blade 202 and a fixed location such as the tubular body 201 to provide a biasing force to open the blades. A control cable 206 may be attached to the movable blade 202 to provide actuation force for closing the movable blade 202.

The dispatch device 200 may incorporate a ratchet mechanism 207 into the design. The ratchet mechanism 207 may feature ratchet teeth 208 in the movable blade 202 with clearance space 209 on either side. A ratchet pawl 210 may interface with the ratchet mechanism 207 to hold the movable blade 202 in progressively more closed positions. The ratchet pawl 210 may be biased by a pawl spring 211 to hold the pawl against the ratchet teeth 208. A release cable 212 may be connected to the ratchet pawl 210 for disengagement of the ratchet mechanism 207.

At the opposite end of the tubular body 201, the dispatch device 200 may include a control handle 213 used to hold the restraining and dispatch device and to operate the dispatch device. The control handle 213 may comprise a trigger member 214 which is used to close the movable blade 202. When pulled, the trigger member 214 pivots around trigger screw 215, which is connected to the control cable 206 and causes a tension on control cable 206 which causes the movable blade 202 to close with respect to the stationary blade 203 against the force of blade spring 205.

Between the movable blade 202 and the stationary blade 203, a blade gap 216 may be present. The blade gap 216 defines an area between the movable blade, 202 and stationary blade 203. Due to the curved nature of the blades, as the movable blade 202 is closed against the stationary blade 203, the tips close to create a closed loop with clearance in the center which allows the animal to be held at first before being released or dispatched.

To release the movable blade, control handle 213 may also include a release member 217 connected to the release cable 212. Moving the release member 217 causes tension in the release cable 212 which causes pawl 210 to be released from the ratchet teeth 208. The blade spring 205 then causes the mobile blade 202 to open.

In some embodiments, the dispatch device 200 may incorporate a folding mechanism to allow for compact storage. The folding mechanism may comprise a body hinge 218 with a hinge pin 219. The body hinge 218 may allow the tubular body 201 to be split and folded.

To secure the dispatch device 200 in its extended position, a latch assembly 220 may be included. The latch assembly 220 may utilize a latch arm 221 that pivots on a latch pin 222. The latch arm 221 may engage with a latch catch 223 to maintain the dispatch device 200 in its extended position.

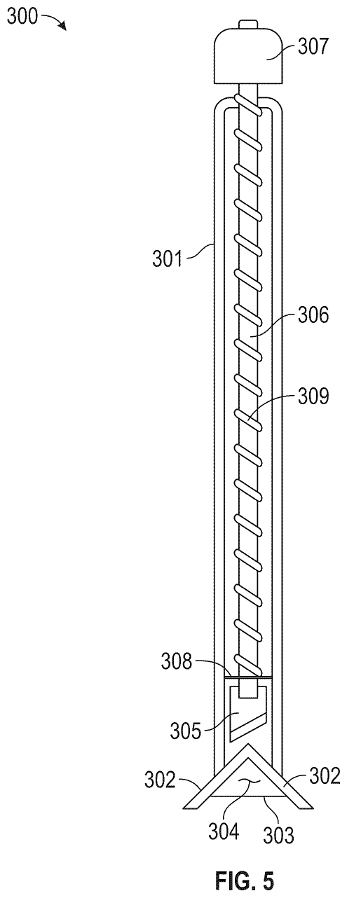

Turning now to FIG. 5, an animal restraining and dispatch device 300 according to embodiments may comprise a main body 301 that extends along the length of the device and comprises the main structural component of the device. The main body 301 may be elongated and have a generally tubular shape. In some embodiments, the main body 301 may be made from materials such as square steel tubing, round steel tubing, PVC pipe, or polymer tubing, depending on the specific design requirements. The main body 301 may include a first end and a second end.

At the first end of the main body 301, the device may include a restraining mechanism. The restraining mechanism may comprise two arms 302 attached to and extending downward from the main body 301. An elastic member 303 may span or be stretched between the two arms 302, which may be used to restrain an animal within the gap 304 between the arms 302.

The dispatch mechanism may comprise a blade 305 having a straight or serrated sharpened edge. In some implementations, the blade 305 may be angled, pointed, or perpendicular to the central axis of the main body 301. The blade 305 may be attached to a spring-loaded rod 306 that extends through the main body 301 and beyond the main body 301.

At the second end of the main body 301, the device may include a dispatch mechanism control. The dispatch mechanism control may be comprised of a striking head 307 attached to the upper end of the rod 306 opposite the blade 305. The striking head 307 may comprise a hollow cap that may be designed to fit over the outside of main body 301, inside the main body 301, or to interfere with the main body 301 to provide a physical stop to keep the blade 305 from over traveling.

To guide rod 306 and facilitate the spring action of the rod 306, one or more block plates 308 may be attached to the main body 301, rod 306, or other portion of the device to provide guidance or a surface for which a compression spring to rest against. In the embodiment shown, a spring 309 is restrained by the block plate 308 which may be attached to the inside of the main body 301 and provide a first surface for the spring to press against. The upper end of rod 306 may also be guided by the upper end of main body 301 or a cap placed thereon with a hole large enough for the rod 306 to pass through.

The spring 309 may extend all the way to the end of the rod where it may be restrained on the other end by the striking head 307. Alternatively, a block plate or other mechanism such as pin, fastener, or wide section may be located on the rod 309 to provide the second surface for the spring 309. Thus, the blade 305 is normally held within main body 301 by the spring 309 until the dispatch mechanism is activated.

To dispatch an animal restrained within gap 304, the user may strike the striking head 307 with a mallet, hammer, fist, or other object. The strike may impact the striking head 307 which may transfer the force to the rod 306 and spring 309, overcoming the spring force and causing the rod 306 to push the blade 305 downward into the gap 304 and into the animal.

The elastic member described herein with respect to the embodiments may be a spring, bungee cord, or piece of rubber. In some embodiments, the elastic member may comprise a metal coil spring made of materials such as stainless steel, chrome silicon, or music wire to provide consistent tension and corrosion resistance. Alternatively, the elastic member may be constructed from elastomeric polymers like natural rubber, silicone rubber, or thermoplastic elastomers, offering flexibility in different environmental conditions.

In some embodiments, the elastic member may feature a composite design, combining multiple materials such as a rubber core with a protective fabric outer layer to enhance durability. The elastic member may be at a fixed tension or may incorporate adjustable tension mechanisms, allowing users to modify the restraining force for different sized animals. Some variations may include elastic members with non-linear force profiles, providing gentler initial restraint that increases with further stretching. Some implementations may feature a series of smaller elastic elements working in parallel rather than a single large member, allowing for redundancy and graduated restraining force.

Components described herein may be attached using mechanical means such as fasteners, welding, adhesives, or press-fitting. Fasteners may include screws, bolts, rivets, pins, or snap-fit connectors selected based on the specific load requirements and materials of the components. Welding techniques such as resistance welding, arc welding, or ultrasonic welding, brazing, or soldering may be employed for metal components to create strong, permanent joints. For plastic or composite parts, solvent welding or heat staking could be utilized.

High-strength structural adhesives, such as epoxies, acrylics, or polyurethanes, may be used to bond components. In some embodiments, a combination of attachment methods may be used—for example, using both adhesives and mechanical fasteners to provide redundancy and enhanced joint strength.

For components requiring frequent disassembly or replacement, quick-release mechanisms like quarter-turn fasteners, cam locks, or magnetic attachments could be incorporated. In areas subject to vibration or shock, self-locking fasteners or thread-locking compounds may be employed to prevent loosening over time.

In some embodiments, the cutting blades may be constructed from various materials to enhance their performance and durability. The choice of blade material may depend on factors such as the intended use, target animal type and size, and environmental conditions.

Stainless steel may be used for the blades due to its corrosion resistance and ability to maintain a sharp edge. Different grades of stainless steel, such as 440C or D 2, may be selected based on their specific properties and intended application.

In some embodiments, high-carbon steel may be employed for the blades to provide excellent hardness and edge retention. This material may be particularly suitable for applications requiring frequent use or cutting through tougher materials.

Titanium alloys may be utilized in some embodiments to create lightweight yet strong blades. These alloys may offer a good balance of strength-to-weight ratio and corrosion resistance, which may be beneficial for portable devices.

In some implementations, ceramic materials may be considered for the blade construction. Ceramic blades may offer exceptional sharpness and wear resistance.

In some embodiments, the blades may be coated with materials such as titanium nitride or diamond-like carbon to enhance their hardness, wear resistance, and corrosion resistance. These coatings may be applied to various base materials to improve overall blade performance.

Some embodiments may utilize powder metallurgy techniques to create blades with unique material compositions. This process may allow for the development of custom alloys with specific properties tailored to the device's requirements.

In some embodiments, the blades may be constructed using a laminated design, combining different materials to leverage their respective strengths. For example, a hard steel core may be sandwiched between layers of more flexible steel to provide both edge retention and toughness.

The blades may comprise a serrated edge. In some embodiments, the serrated edge may have a variety of tooth configurations to enhance cutting effectiveness. For example, the serrations may be uniformly spaced or have variable spacing along the blade edge. The teeth of the serrations may have different profiles such as triangular, curved, or scalloped shapes.

In some embodiments, the blade edge may feature a combination of serrated and straight sections to provide versatility in cutting different materials or animal tissues. The serrations may be unidirectional or bidirectional, allowing for effective cutting in one or both directions of blade movement.

Some variations may include specialized coatings applied to the serrated edge to enhance durability, reduce friction, or provide corrosion resistance. For instance, the blade edge could be coated with titanium nitride, diamond-like carbon, or other hard-wearing materials.

In other embodiments, the serrated edge may be removable or replaceable, allowing for easy maintenance or customization of the cutting edge for different applications. The blade may also feature multiple rows of serrations at different angles to create a more aggressive cutting action.

Some embodiments may incorporate micro-serrations along the edge, visible only under magnification, to provide an extremely sharp cutting surface while maintaining the appearance of a straight edge. These micro-serrations could be created through processes such as laser etching or precision grinding.

The implementations set forth in the foregoing description do not represent all implementations consistent with the subject matter described herein but are examples consistent with the disclosed subject matter. Although variations have been described in detail above, other modifications or additions may be possible. In particular, further features and/or variations may be provided in addition to those set forth herein. For example, the implementations described above may be directed to various combinations and subcombinations of the disclosed features and/or combinations and subcombinations of several further features disclosed above. In addition, the logic flow depicted in the accompanying figures and/or described herein do not necessarily require the particular order shown, or sequential order, to achieve desirable results. It will be readily understood to those skilled in the art that various other changes in the details, materials, and arrangements of the parts and method stages which have been described and illustrated in order to explain the nature of this inventive subject matter may be made without departing from the principles and scope of the present disclosure.

What is claimed is:

1. An animal restraining and dispatch device, comprising:
an elongated body having a first end and a second end;
a blade-support portion extending from the first end of the elongated body;
a pair of opposing blades pivotably supported by the blade-support portion, the opposing blades being movable between an open position and a closed position to sever an animal positioned between the opposing blades;
an elastic member having a first end attached to a first one of the opposing blades at a first attachment point and a second end attached to a second one of the opposing blades at a second attachment point, the elastic member extending between the opposing blades and spanning a blade gap between the opposing blades when the opposing blades are in the open position, the elastic member being configured to temporarily restrain the animal within the blade gap before movement of the opposing blades toward the closed position; and
a blade control disposed at the second end of the elongated body and operably connected to the opposing blades to move the opposing blades from the open position toward the closed position.

2. The animal restraining and dispatch device of claim 1, wherein the blade-support portion comprises a pair of support arms extending from the first end of the elongated body, and wherein the opposing blades are pivotably supported by the pair of support arms.

3. The animal restraining and dispatch device of claim 1, wherein the first attachment point comprises a first attachment opening formed in the first one of the opposing blades and the second attachment point comprises a second attachment opening formed in the second one of the opposing blades, and wherein the first and second ends of the elastic member are secured to the first and second opposing blades at the first and second attachment openings, respectively.

4. The animal restraining and dispatch device of claim 3, wherein each of the first and second attachment openings is formed through a respective one of the first and second opposing blades at a location between opposing lateral edges of the respective blade.

5. The animal restraining and dispatch device of claim 1, wherein the animal restraining and dispatch device comprises a spring-loaded rod attached to the dispatch mechanism and the dispatch mechanism control.

6. The animal restraining and dispatch device of claim 1, wherein the blade control comprises a lever to move the opposing blades toward the closed position.

7. The animal restraining and dispatch device of claim 6, wherein the blade control further comprises a cable operably connecting the lever to the opposing blades such that actuation of the lever tensions the cable to move the opposing blades toward the closed position.

8. The animal restraining and dispatch device of claim 7, wherein the cable is operably connected to the opposing blades such that tension applied to the cable causes the opposing blades to pivot toward the closed position.

9. The animal restraining and dispatch device of claim 8, wherein the blade control comprises a spool around which the cable is wound.

10. The animal restraining and dispatch device of claim 9, wherein rotation of the spool winds the cable around the spool to increase tension in the cable and move the opposing blades toward the closed position.

11. The animal restraining and dispatch device of claim 10, wherein the lever is operably coupled to the spool such that actuation of the lever rotates the spool.

12. The animal restraining and dispatch device of claim 11, wherein the lever drives a pawl that engages a gear attached to the spool to rotate the spool.

13. The animal restraining and dispatch device of claim 12, further comprising a lock member configured to engage the gear to prevent unintended rotation of the spool.

14. The animal restraining and dispatch device of claim 13, wherein the blade-support portion comprises a pair of support arms extending from the first end of the elongated body, the opposing blades being pivotably supported by the pair of support arms, wherein the first attachment point comprises a first attachment opening formed through the first one of the opposing blades and the second attachment point comprises a second attachment opening formed through the second one of the opposing blades, the first and second ends of the elastic member being secured to the first and second opposing blades at the first and second attachment openings, respectively, wherein each of the first and second attachment openings is located between opposing lateral edges of the respective blade, and wherein the lock member is biased toward engagement with the gear by a lock spring.

15. A method of restraining and dispatching an animal, comprising:
positioning an animal within a gap between opposing blades at a first end of an elongated device;
restraining the animal using an elastic member spanning the gap; and
activating a dispatch mechanism at the first end using a control mechanism at a second end of the elongated device.

16. The method of claim 15, wherein activating the dispatch mechanism comprises pulling a cable connected to the opposing blades to close the blades.

17. The method of claim 16, wherein pulling the cable comprises rotating a spool around which the cable is wound.

18. The method of claim 17, wherein rotating the spool comprises actuating a lever operably connected to the spool.

19. The method of claim 18, further comprising engaging a lock member with the spool to prevent unintended rotation of the spool.

20. The method of claim 19, further comprising disengaging the lock member to release the opposing blades after dispatching the animal.
